(19) United States
(12) Patent Application Publication
(10) Pub. No.: US 2006/0142537 A1
(43) Pub. Date: Jun. 29, 2006

(54) Decomposition-resistant polyamide and method for the production thereof

(75) Inventor: Eduard Schmid, Bonaduz (CH)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: EMS-CHEMIE AG, Domat/Ems (CH)

(21) Appl. No.: 10/530,957

(22) PCT Filed: Oct. 7, 2003
(86) PCT No.: PCT/EP03/11085

§ 371 Date: Mar. 1, 2006

(30) Foreign Application Priority Data
Oct. 11, 2002 (DE) 102 47 470.2

(51) Int. Cl. C08G 69/08

(52) U.S. Cl. 528/310

(57) ABSTRACT

The invention relates to a decomposition-resistant polyamide which is produced by means of anionic polymerisation of at least one lactam in the presence of at least one basic catalyst and optionally at least one activator, a deactivator consisting of a proton donor and an amine being added following the completed polymerization in the melted state.

The invention relates to a new polyamide which is degradation-resistant during remelting and is obtainable by anionic polymerisation, a specific desactivator being added to the polymer in the melt. The invention relates furthermore to a method for producing a corresponding polyamide.

The disadvantage that anionic polylactam melts or anionically produced polylactam are subjected to significant viscosity variations, in particular chain length degradation, in the melt state during processing, is already described in DE O 22 41 131 (1) and in DE O 22 41 132 (2) and in addition remedial measures are proposed as follows: in the case of (1), malonic acid ethyl ester is mixed into an anionically produced and still highly flowable polylactam-12 within 30 minutes, and it is observed over a period of 4 h at 240° that the melt initially drops a little in its viscosity and then increases again, whilst in the comparative test, without addition of malonic acid ester, the polylactam cross-links and loses its flowability entirely. The same behaviour is observed in (2) upon addition of tert.butyl alcohol under the same conditions, in both cases respectively the anionic polyamide-12 being produced identically.

In DE O 22 41 133 (3), anionically produced polylactam-6 is re-extruded twice at 230° with the addition of a molar excess of 60% of p-toluenesulphonic acid or p-toluenesulphonic acid esters, as a result of which the changes in the molecular weight can be reduced significantly. In particular when using the specially effective p-toluenesulphonic acid, the polylactam melt becomes highly acidic, which causes corrosion on the processing machines, such as extruders and injection moulding machines, and makes the polymer susceptible to hydrolytic degradation in practical use, in particular in humid surroundings.

It should be mentioned however that in particular conventionally anionically produced, non-neutralised polyamide sustains a massive chain length or viscosity degradation during remelting. Reference is made in this respect to EP 0 905 166 A1.

In EP 0 905 166 A1 in paragraphs (0007) and (0011) K. UEDA et al.: “Stabilization of High Molecular Weight Nylon 6 Synthesized by Anionic Polymerization of ε-Caprolactam”, Polymer Journal, Vol. 28, No. 12, pp. 1084-1089 (1996) is cited. The corresponding patent application JP 08 157594 A stems from the co-author K. TAI, according to Patent Abstracts of Japan, Vol. 1996, No. 10, 1996-10-31. In these two items of literature, complex methods which are not suitable in practice for preventing the degradation of the melt are described, in which methods polylactam-6 is dissolved in organic solvents, containing carboxylic acid, and is thereafter precipitated, as a result of which the anionic polymerisation catalyst is removed or loses its activity.

In the meantime, polymerisation methods for lactams have also been developed, in which not simply a basic catalyst is used for the lactam polymerisation but so-called liquid systems, which directly initiate the accelerated, anionic polymerisation, are added as sole component to the lactam melt in a small weight proportion, which is effected preferably directly in a twin-shaft extruder and after which the entire polymerisation course is effected within a few seconds. Such polylactam melts are extremely viscosity-unstable and are subjected to strong viscosity variations during further processing so that their practical value is greatly restricted. Such liquid systems are described for example in WO 01/46292 A1 and WO 01/46293 A1.

Starting herefrom, it is therefore the object of the present invention to provide a polyamide which has been produced also preferably by a method, as described in WO 01/46292 A1 or WO 01/46293 A1, which polyamide has good physical properties, in particular with respect to processing and stability, and has at the same time a low viscosity degradation during re-melting.

The invention is achieved with respect to the polyamide by the features of patent claim 1 and with respect to the method for production by the features of patent claims 21 and 25. The sub-claims display advantageous developments.

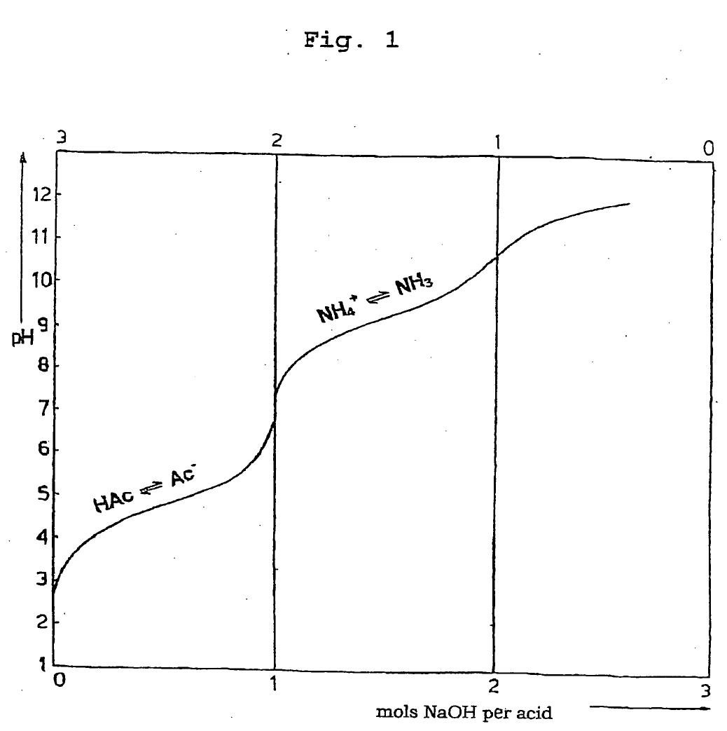

The inventor was able to show that the disadvantages of the state of the art are eliminated, i.e. that the disadvantage of the viscosity instability disappears if, directly after completed polymerisation, before secondary reactions begin, a special desactivator is added to the polylactam melt. The thus obtained polyamide is thereafter degradation-resistant. According to the invention, a desactivator is added which comprises a proton donor and an amine. The acid must thereby protonate all the basic positions of the polyamide chain which stem from the catalyst. This means that the concentration of acid groups (e.g. —COOH) must be at least as large as the basicity stemming from the catalyst but smaller than the sum of the basicity and the concentration of amine function. It is therefore also favourable to mix the desactivator homogeneously into the melt in order that as far as possible all basic positions are reached. This obviously leads to the fact that the polylactam, during further processing, is so good in the melt state with respect to degradation-resistance (also as far as the aspect of hydrolysis sensitivity is concerned) as a hydrolytically produced polylactam. The desactivator according to the invention hence has the effect that amine is present in addition to some protonated amine and a higher pH value is set than is the case with exclusive use of a carboxylic acid, in which —COOH is present in addition to —COO⁻, which increases the hydrolysis sensitivity. The mechanism can thereby be explained in principle by FIG. 1. The illustrated pH buffer areas correspond in fact to acetic acid and ammonia in aqueous solution but the situation of the curve course also remains approximately the same for the substances according to the invention in the polyamide. Initially, the carboxylic acid yields the proton to the amine so that protonated amine is formed. Upon contact with the basic (anionic) polyamide melt, the proton (H⁺) is now transferred to the highly basic positions (—N⁻—) of the lactam chain, by means of which the polyamide chain is neutralised. The proton donor is used preferably in a low excess relative to the catalyst, and the amine proportion is chosen so as to remain in the amine buffer area which is the case when, as a second condition, the concentration of the acid groups is smaller than the sum of the basicity and the concentration of amine function. Hence a pH range of approximately 8-10 remains which is optimal for the hydrolysis stability of the polyamide in practical use.

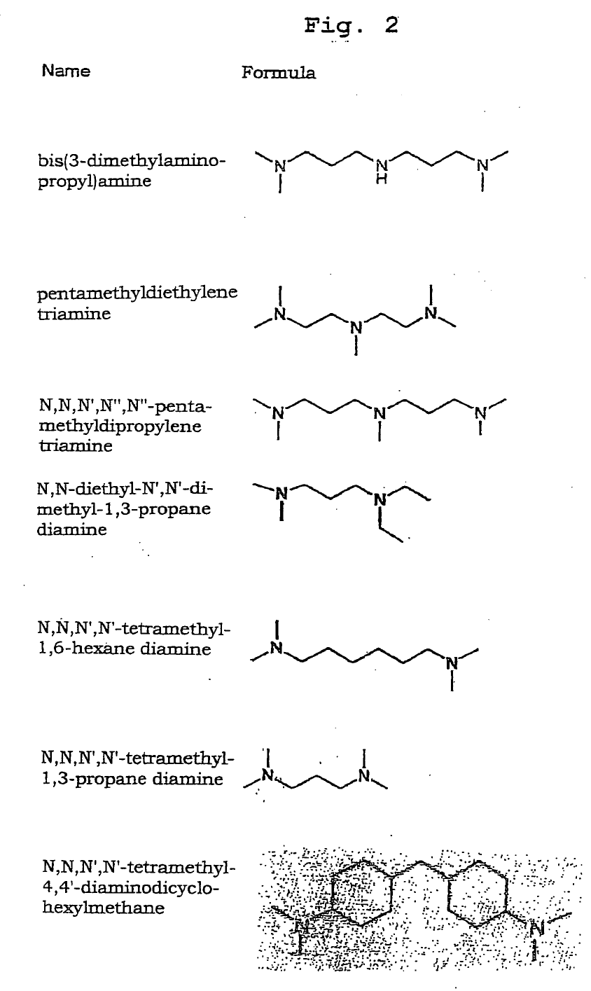

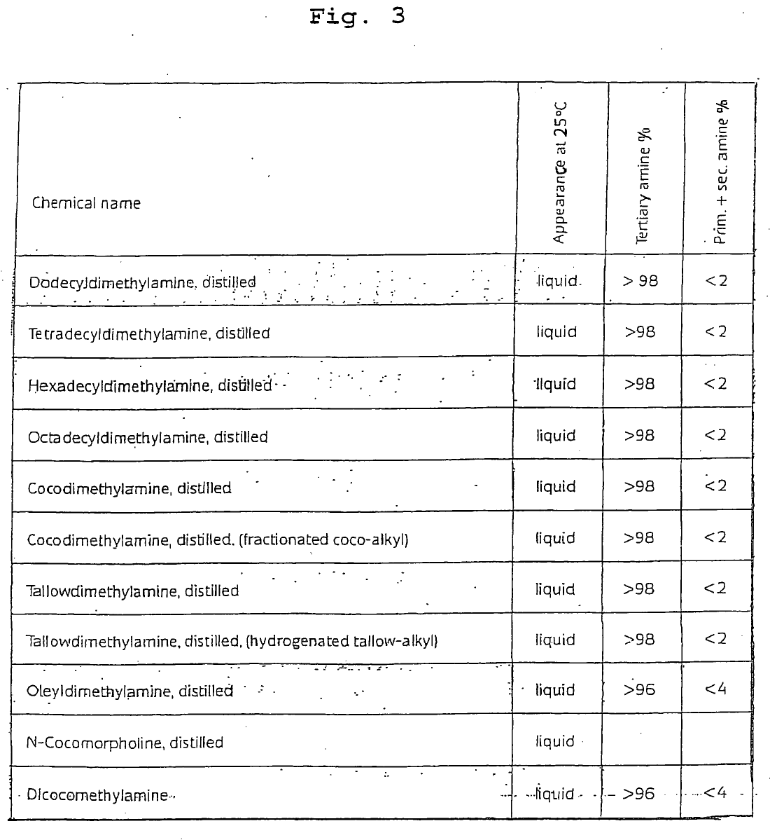

In particular non-volatile secondary or tertiary amines are suitable as amines for the desactivator system. It is thereby particularly preferred if the amine is trialkylated or if it is a secondary amine, in the case of which the amine group is sterically hindered. So it is secured that the polyamide chain is not affected in the sense of degradation/transamidations. Examples of preferred amines, which can be used for the desactivator according to the invention, are cited in FIGS. 2 to 4.

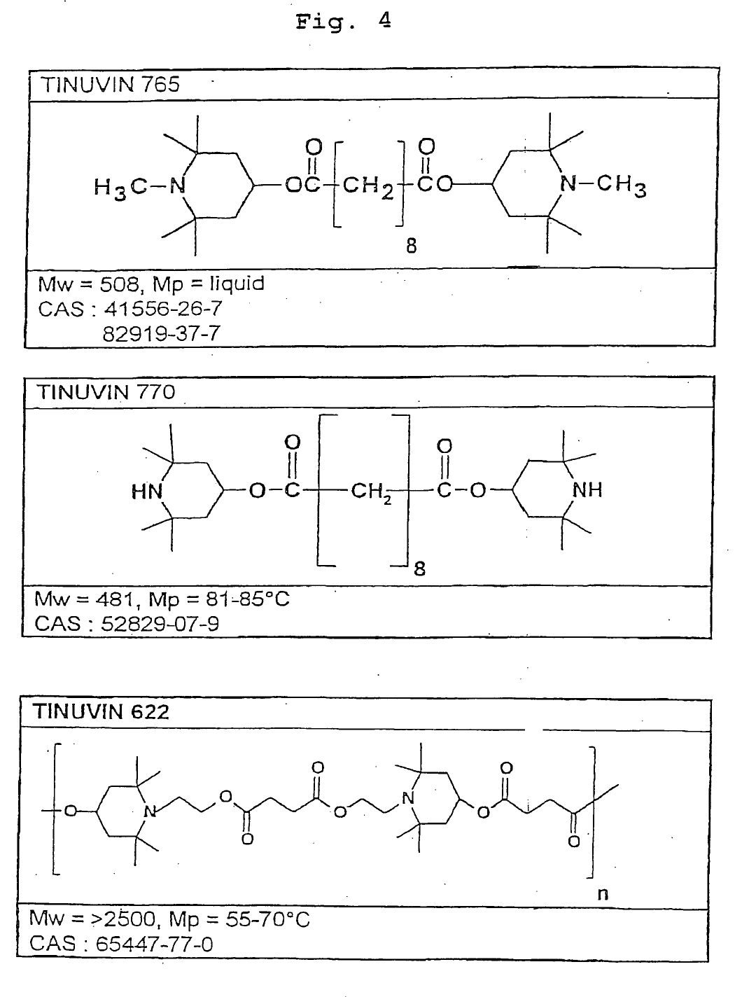

The compounds listed in FIG. 4 are known by the abbreviation HALS (Hindered Amine Light Stabilisers). Their use as amine in the sense according to the invention gives the additional advantage that the polylactam is protected at the same time against the effect of weathering, in particular UV radiation. The proton donor of the desactivator is preferably an organic carboxylic acid, usually a polycarboxylic acid, e.g. an oligomeric, wax-like product, such as e.g. an acid polyethylene wax, which contains carboxyl groups, or occurs as a cooligomer or copolymer. It is particularly preferred hereby if the copolymer is an ethylene(meth)acrylic acid copolymer.

The desactivator with proton donor and amine can, as described above, comprise two isolated compounds which are then mixed in a ratio which permits thereafter complete protonation of the highly basic PA chains and the amine compound is thereby still partly protonated and hence in the amine buffer area (ammonium⇄free amine).

However, it is particularly preferred with the polyamide according to the invention if the desactivator comprises a single compound which has at least one proton-donating group and at least one amine group. An extensive advantage is involved therewith. Hence only one compound must in fact be mixed homogeneously into the polylactam melt. In the case where the desactivator comprises a single compound, this is selected preferably from compounds of the general formula 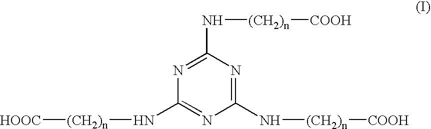
1 with preferably n=1 to 10, particularly preferred n=5.

In particular embodiments of the invention, such compounds can however also be used in combination with additional amine compounds.

The polyamide according to the invention corresponds in its behaviour to a hydrolytically produced polylactam, as is known from the state of the art. It is particularly preferred thereby if the lactam has 6-12 C atoms and very particularly preferred here, if lactam 6 and/or lactam 12 or mixtures thereof are used.

It is possible to use as catalysts all those which are known per se in the state of the art, in particular alkali lactamate or a lactamate-forming compound.

For the activators, those selected from the group of acylated lactams, isocyanates and carbodiamides, which can also be present in capped or cyclised form, are preferred.

As mentioned initially already in the description of the state of the art, it is thereby particularly preferred if a catalytically acting liquid system is used for the polymerisation control, which system contains the activator and the catalyst in a liquid polar aprotic salvation medium. Systems of this type are described e.g. in WO 01/46292 A1 and WO 01/96293 A1. Reference is made expressly to the disclosure content of these documents.

The polyamide according to the invention can be present either as a granulate or as shaped bodies like injection moulded parts, fibres, films, plates, pipes, coverings, shaped or profile pieces. The moulded articles can be produced thereby either directly from the melt according to the invention or via the granulate intermediate step.

The invention therefore relates also to a method for producing degradation-resistant polyamide. According to the invention, the method is thereby implemented such that, after completed polymerisation, a desactivator in the form of a proton donor and of an amine is mixed into the polyamide melt. The desactivator is hence added to the highly basic polylactam melt, as a result of which the disadvantage of viscosity instability is eliminated. This can obviously be attributed to the fact that the addition is effected directly after completed polymerisation before secondary reactions can begin.

It is thereby important in the method according to the invention that the desactivator is mixed in homogeneously. The method according to the invention can thereby be implemented continuously in a mixer, e.g. in an extruder. It is preferred thereby to use a twin-screw extruder with a suitable mixing part. It is thereby ensured that the desactivator is distributed rapidly and completely in the melt. The desactivator can thereby be added, in a preferred variant, as a pre-distributed master batch melt, e.g. by means of a side feeder. Subsequently, the melt can then be supplied for shaping or it is withdrawn in strand form by a tool, is granulated and the granulate is dried for further use.

As an alternative to the above-described method course, it is also possible that the polymerisation method is controlled such that the polymerisation is ended just when the melt emerges from the extruder, e.g. as a strand, and the latter is thereafter cooled in a water bath for the purpose of granulation. In this case, the desactivator can then be added during the subsequent remelting and be mixed homogeneously into the polylactam melt and can take effect. The addition is thereby effected best in the extruder infeed, preferably either as a master batch granulate or by applying to the polyamide granulate by means of adhesives. As a result, a degradation-resistant polyamide is achieved.

In the method according to the invention, a desactivator is used as described already in the explanations about the polyamide. The same applies to the lactam, the activator and the catalyst. It is preferred also in the method if a catalytically effective liquid system is used, in which the activator and catalyst are present in a liquid polar aprotic solvation medium. With a liquid system of this type, the best polymerisation results are achieved with the method according to the invention.

The use of a desactivator, as explained above, has the advantage in addition that, when used as a master batch, further additives for improving the properties and/or processing can be jointly contained in the master batch.

The master batch is produced by incorporating the desactivator component in the melt of a thermoplastic. This thermoplastic represents the master batch carrier and is thereby preferably polyamide. The master batch, as known from the state of the art and mentioned previously, can contain further additives.

Should the desactivator according to formula 1 be used as master batch, then a preceding drying must be effected since the compound occurs as filter cake with a solid proportion of approximately 65%. After drying, the dry or dried-on substance, together with the carrier granulate which is preferably polyamide, is melted, if necessary any water which is still being released being removed. The quantity ratios of possible further additives should be chosen in an appropriate manner so that the end concentration in the finished polyamide corresponds to practical demands.

Since the lactam polymerisation and the subsequent stabilisation of the melt against viscosity changes in the preferred embodiment according to the invention is implemented continuously in particular in a twin-shaft extruder, all the method steps and modifications which are known and common with a polyamide can also be effected together with the deactivation of the catalyst or subsequently in the same extrusion pass. These are for example addition of stabilisers, colourants, plasticizers, flame retardants, impact modifiers, reinforcement agents, such as glass and minerals, and also combinations of these additives. There can be added to the desactivator master batch, e.g. stabilisers (against heat and weathering), processing aids, soluble colourants and pigments (in particular carbon black). The remaining additives are preferably added separately to the melt.

The invention is now intended to be illustrated in depth with reference to a few examples.

All experiments were implemented by means of liquid catalysts, which initiate alone the accelerated, anionic lactam polymerisation and control its course. The experiments were implemented on the basis of a continuous method course using a twin-screw extruder, the ZSK-25 of the firm Werner and Pfleiderer, Stuttgart, DE, and are based on lactam 12. The lactam 12 in the form of pills and dried to a water content of below 0.01% was supplied continuously to the extruder infeed.

In order to initiate and implement the accelerated, anionic lactam polymerisation, 2 different types of liquid catalyst (FK) were used corresponding to the following chemical composition:
a) Methyl phenyl carbamate/Sodium salt, dissolved at 1.25 mol/kg in N-methylpyrrolidone
b) Acetanilide/Sodium salt/phenyl isocyanate addition product, dissolved at 1.0 mol/kg in N-octyl pyrrolidone which jointly contains N-methylpyrrolidone in a weight proportion of 25%.

The sought polymerisation degree expressed as a number average was respectively set such that the added number of lactam molecules is established per active FK particle used, e.g. 180 lactam 12 molecules per 1 FK particle, and this value is designated as PG.N. In order to have a good comparison basis, the method was implemented in two stages for the examples, wherein the first extrusion pass corresponds to the polymerisation and, in the second extrusion pass, the catalyst deactivation was effected, and the extrusion conditions were set such that, after the completed first pass of the melt through the extruder, the polymerisation was just completed.

The normally chosen polymerisation conditions—with respectively low adaptations to the respective variants—are thereby: screw construction such that feeding of lactam in pill form is readily possible, thereafter in housing zone 2 to an opening for the continuous metered addition of the liquid catalyst, thereafter the mixing and then the polymerisation zone follow essentially with conveying elements to the screw. For the course of the polymerisation, the FK was dosed into the extruder zone 2 by means of a continuously conveying pump, usually a so-called HPLC pump.

Suitable, general test data of the ZSK for the polymerisation course are:

| | | |
|---|---|---|
| throughput | 12 | kg/h |
| set temperature, polymerisation zone | 260° | C. |
| speed of rotation | 180 | rpm |

In the tables relating to the experiments the following mean:
MvI the melt volume index, measured at a temperature of 275° C. and a load of 5 kg, according to EN.ISO 307
r.V. the relative solution viscosity, measured on a 0.5% solution of the polymer in m-cresol according to EN.ISO 307
Irganox 1310 a monocarboxylic acid by Ciba SC with a sterically hindered phenol radical
Licowax S an industrial montanic acid quality by Clariant
Surlyn 9320 a Zn ionomer made by Du Pont, corresponding to a partly neutralised ethylene acrylic acid copolymer which still jointly contains flexibilising monomer components
Lucalen 2920 an ethylene acrylic acid copolymer by BASF
Irgacor L 190 a trifunctional cyclic carboxylic acid with 6 N atoms in the molecule by CIBA SC—formula I
Armeen DM 16D hexadecyldimethylamine by AKZO
Armeen HT hydrogenated tallow oil amine by AKZO
dodecanedioic acid corresponds to the linear C12 dicarboxylic acid

The tests are numbered in the following and the comparative tests designated respectively with Vgl.

### EXAMPLES 1-10

In these tests, lactam 12 with a throughput of 12 kg/h and a set temperature of the extruder housing of the polymerisation zone of 260° C. is converted with addition of FK, type a) corresponding to a PG.N of 180. The basicity resulting from the catalyst is thereby 27 μequivalent/g (μe/g) and a value of 2.167 was measured as r.V.

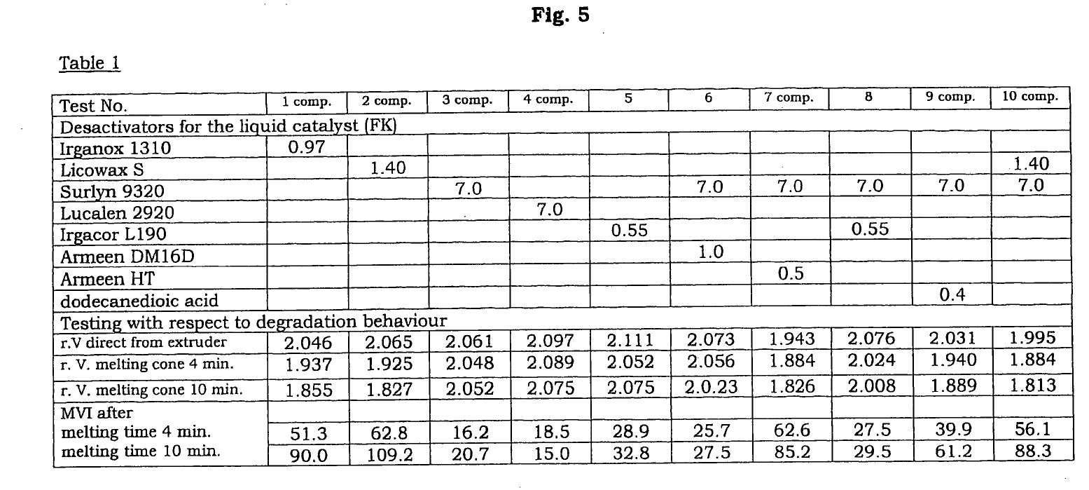

The components for the tests and the test results are compiled in FIG. 5, Table 1, test 5, 6 and 8 corresponding to the state according to the invention and the remaining tests being comparative tests.

The quantity proportion of compound deactivating the catalyst is calculated respectively such that it is 35 μe/g in the compounded mixture, i.e. exceeds the basicity of the polylactam chain by 7 μe/g which is necessary in practice because usually commercial products with varying acidity were used and also in order to ensure adequate diffusion of the acid compound to the basic centres in the polylactam.

A good desactivator system for the catalyst, in the case of PG.N 180 produces here a time-constant MVI of 20-40 which corresponds to good processability of the polylactam, in particular in extrusion processes, e.g. into pipes.

As our tests and comparative tests have shown, this applies to the formulations according to the invention in an outstanding manner, whilst monocarboxylic acids have a slight chain-splitting effect which is expressed in a high MVI value, which also verifies the drop in the r.V. In contrast, the polymers with —COOH, sterically screened in their chain, produce low MVI values, and no degradation, which can be detected via the r.V., is produced.

Furthermore, a dimethylated monoamine was added to the ionomer in test 6 and a normal linear, primary monoamine in comparative test 7. Whilst the desired MVI results in test 6 according to the invention and the r.V. only changes slightly, a significant viscosity drop, which can be measured via the r.V. and the MVI occurs in comparative test 7. In test 8, with addition of Irgacor L 190 to the ionomer, the desired behaviour results, in contrast to comparative test 9 and 10 where joint use of monomeric acid leads again to a significant viscosity drop with a high MVI value.

Even during thermoplastic conversion in injection moulding, the formulations according to the invention produce test samples of excellent intrinsic colour and with a good surface which is a substantial advantage in the case of pigmentation. In order to test further the stability of the experimental formulations by way of comparison, they were extruded for a second time on a laboratory twin-shaft extruder, a Collin table compounder ZK 25 T. The MVI values of the formulations according to the invention were again after 4 min. melting time in the range of 25-40 which is favourable for the PG.N (according to test number and MVI value: 5:34, 6:28 and 8:26), whilst the comparative tests 3 and 4 only with acid copolymer were below 25 and the variants with monomer carboxylic acid respectively significantly above that.

On selected formulations from test series 1-10, in addition the degradation in the case of increased water contents of 0.2 and 0.5% by weight was examined. Such water contents are not common in practice and were implemented exclusively for comparing the degradation behaviour. The MVI values at high water contents are not very informative, relative to the degradation prevention since water serves directly itself as active flow aid for the polylactam but the r.V. values can be used for evaluating the degradation behaviour.

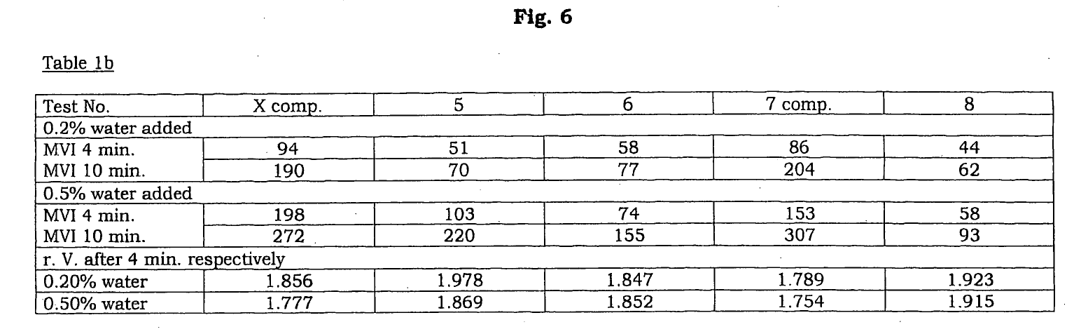

The results are compiled in FIG. 6, Table 1b, the test numbers being retained and the base polyamide which contains no desactivator, being jointly tested as comparison with the sign X. The tests verify that X—without desactivator—sustains a massive degradation during remelting. Also the formulation corresponding to comparative test 7, where sterically screened —COOH is combined with primary amine, degrades greatly.

As the r.V. values verify, the degradation in the case of the formulations according to the invention is significantly lower despite the high water content.

### EXAMPLES 11-15

Tests 11-15 closely follow the preceding tests and comparative tests, however concerning exclusively tests according to the invention, and thereby, with an identical extruder construction, again carefully dried lactam 12 was polymerised this time using FK b). A rotational speed of 180 rpm was thereby set and a throughput of 14 kg/h was operated and also the set temperatures of the extruder housing were slightly raised with increasing PG.N. The FK proportion was dosed respectively such that PG.N values of 180-240 resulted. A proportion of the polymers was then reextruded again on the Collin laboratory extruder with the addition of F1 (formula 1) to 130% relative to the basicity of the polymer at 150 rpm and 270° C. set temperature and 3 kg/h throughput. The lactam 12 residual contents of all polymers were below 0.3% by weight and they all have a narrow molecular weight distribution, almost identical to hydrolytic polyamide 12.

In the case of this re-extrusion, a certain molecular weight decrease resulted because Irgacor L 190 must melt as well and must firstly be distributed homogeneously in the entire polylactam melt in order to develop the deactivating effect on the catalyst.

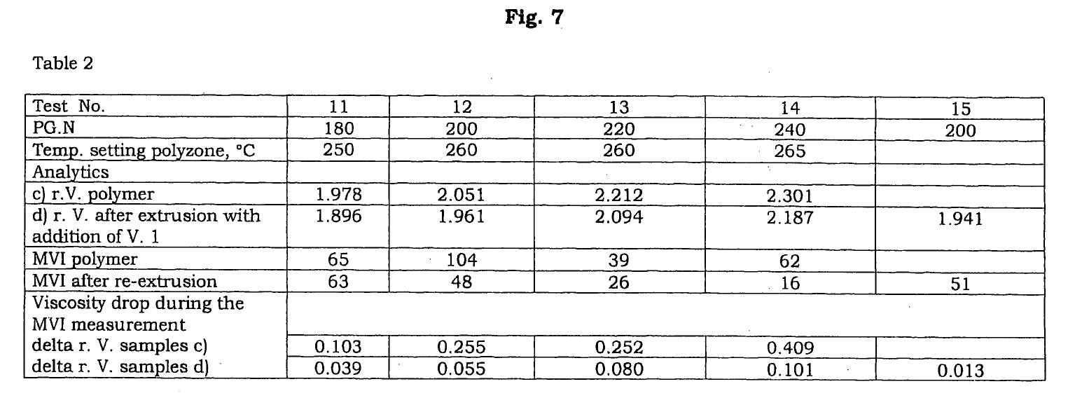

The stabilising effect is now evident upon evaluation of the analysis results, as are compiled in FIG. 7, Table 2.

The MVI values of the pure polymers are high and vary significantly which indicates the still present instability in the melt state. This is also evident in the high delta for the r.V. of these samples c) during MVI measurement at only 4 min. melting time. The MVI values of the re-extruded samples d) are lower in every respect and constantly decrease with increasing PG.N, which corresponds to expectation. The degradation which is thereby detectable via the r.V., as delta r.V., is now very much lower which proves the achieved degradation-resistance of the melt. The polymer compounded already with Irgacor L 190 in test 12 with PG.N 200 was extruded in addition for a second time as test 15 on the Collin laboratory extruder. A comparison of the r.V., of the MVI and of the delta—r.V.—samples d) verify the good processing stability of these formulations provided with Irgacor 1190 during remelting and processing.

1. Degradation-resistant polyamide producible by anionic polymerisation of at least one lactam in the presence of at least one basic catalyst and if necessary at least one activator, with addition of a desactivator after completed polymerisation in the melt state, wherein the desactivator comprises a proton donor and an amine.

2. Polyamide according to claim 1, wherein the amine is a non-volatile secondary or tertiary amine.

3. Polyamide according to claim 2, wherein the amine is an N-dimethylated fatty amine with 12-18 C atoms.

4. Polyamide according to claim 3, wherein the amine function is sterically hindered.

5. Polyamide according to claim 4, wherein the amine is a HALS amine.

6. Polyamide according to claim 1, wherein the proton donor is an organic carboxylic acid or polycarboxylic acid.

7. Polyamide according to claim 6, wherein the organic carboxylic acid is present in the form of an oligomeric wax-like product, preferably as polyethylene wax, which contains carboxyl groups, or as a cooligomer or copolymer.

8. Polyamide according to claim 6, wherein the proton donor is an ethylene(meth)acrylic acid oligomer or polymer.

9. Polyamide according to claim 8, wherein the polymer is an ethylene(meth)acrylic acid copolymer.

10. Polyamide according to claim 6, wherein the carboxylic acid is a copolymer with monomers containing acid groups, which occur partially as a salt (ionomers) and the cation is preferably Zn⁺⁺.

11. Polyamide according to claim 1, wherein the desactivator comprises a compound, which has at least one proton-donating group and at least one amino group.

12. Polyamide according to claim 11, wherein the desactivator is selected from compounds of the general formula I 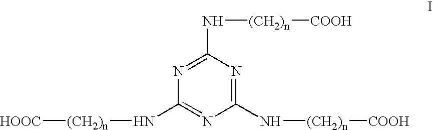
with n=1 to 10, preferably 5.

13. Polyamide according to claim 11, wherein a non-volatile secondary or tertiary amine is added in addition to the desactivator.

14. Polyamide according to claim 1, wherein the polyamide has a relative viscosity ηᵣₑₗ of 1.5-4.0, measured in a 0.5% by weight solution in m-Cresol according to EN.ISO 307.

15. Polyamide according to claim 1, wherein the lactam has 6-12 C atoms, preferably is lactam 6 and/or lactam 12 or a mixture thereof.

16. Polyamide according to claim 1, wherein the catalyst is an alkali lactamate or a lactamate-forming compound.

17. Polyamide according to claim 1, wherein the activator is selected from the group of acylated lactams, isocyanates and carbodiimides which can be present also in capped or cyclised form.

18. Polyamide according to claim 1, wherein a liquid system, which contains the activator and the catalyst in a liquid polar aprotic solvation medium, is used for the polymerisation control.

19. Polyamide according to claim 1, wherein the polyamide is present as a granulate.

20. Polyamide according to claim 1, wherein the polyamide occurs as moulded articles in the form of injection moulding parts, fibres, films, plates, pipes, coatings, shaped or profile pieces.

21. Method for continuous production of a degradation-resistant polyamide starting from the resulting polylactam comprising at least one lactam with addition of at least one basic catalyst and if necessary of at least one activator by means of a polymerisation at a temperature between 140 and 320° C., wherein a proton donor and an amine is added to the resulting polylactam in the melted aggregate state as desactivator.

22. Method according to claim 21, wherein the desactivator is added in the form of a melted master batch.

23. Method according to claim 21, wherein the method is implemented in a continuous mixer, e.g. in an extruder.

24. Method according to claim 23, wherein the method is implemented in a twin-screw extruder.

25. Method for processing polyamide or the polymer blend thereof, which was produced by anionic polymerisation of lactam in the presence of at least one basic catalyst and if necessary at least one activator, in which method the polyamide or the polymer blend thereof is melted and, before further processing, a proton donor and an amine is added to the melt in the molten state as desactivator.

26. Method according to claim 25, wherein the desactivator in the form of a master batch granulate is added before remelting to a PA granulate produced via anionic polymerisation.

27. Method according to claim 25, wherein, after granulation of the polyamide, the desactivator is applied to the polyamide granulate by means of adhesion-promotor before processing into the moulded article.

28. Method according to claim 25, wherein the polyamide or the polymer blend thereof is comminuted before thermoplastic conversion into the finished part as an intermediate method step and is present thereby as a granulate.

29. Method according to claim 21, wherein a non-volatile secondary or tertiary amine compound is used as amine.

30. Method according to claim 29, wherein the secondary amine compound carries at least one sterically hindered C₁-C₁₈ alkyl group.

31. Method according to claim 21, wherein an organic carboxylic acid is used as proton-donating compound.

32. Method according to claim 31, wherein the proton donor is an acidic polyethylene wax in which the carboxylic acid is preferably part of the chain.

33. Polyamide according to claim 31, wherein the proton donor is an ethylene(meth)acrylic acid copolymer.

34. Polyamide according to claim 31, wherein the proton donor is a copolymer with monomers containing carboxylic acid groups, which monomers are present partially as a salt (ionomers), the cation preferably being Zn⁺⁺.

35. Method according to claim 21, wherein the concentration of acidic groups (e.g. —COOH) is at least as great as the basicity originating from the catalyst but smaller than the sum of the basicity and the concentration of amine functions.

36. Method according to claim 21, wherein a compound is used as desactivator which has at least one proton-donating group and at least one amine group.

37. Method according to claim 36, wherein the compound is selected from the general formula I 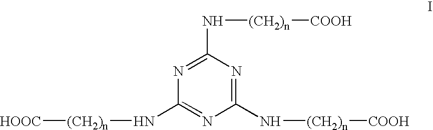
with n=1 to 10, preferably n=5.

38. Method according to claim 21, wherein the lactam has 6-12 C atoms, preferably lactam 6 and/or lactam 12.

39. Method according to claim 21, wherein the catalyst is an alkali lactamate or a compound forming a lactamate.

40. Method according to claim 21, wherein the activator is selected from the group of acylated lactams, isocyanates and carbodiimides, which can also be present in capped or cyclised form.

41. Method according to claim 21, wherein a catalytically acting liquid system is used for the polymerisation control, in which system the activator and the catalyst are contained in a liquid polar aprotic solvation medium.

42. Method according to claim 21, wherein the desactivator, if necessary with further additives, is added in the form of a master batch, the master batch carrier being a thermoplastic.

43. Method according to claim 42, wherein the master batch is produced by incorporation of the desactivator components in the melt of a thermoplastic and the thermoplastic is preferably polyamide and the master batch can contain further additives, in particular stabilisers.

44. Use of the method according to claim 21 for producing granulate for the further thermoplastic processing into polyamide moulded articles, or for direct production of moulded articles.

45. Use of the method according to claim 25 for recycling polyamide or the polymer blends thereof.
